(19) United States
(12) Patent Application Publication
(10) Pub. No.: US 2026/0139967 A1
(43) Pub. Date: May 21, 2026

(54) METHOD FOR CREATING A MAP

(71) Applicant: Robert Bosch GmbH, Stuttgart (DE)

(72) Inventors: Henning Lategahn, Pfinztal (DE); Jan Rohde, Dettingen Unter Teck (DE); Julius Ziegler, Karlsruhe (DE); Philipp Crocoll, Stutensee (DE)

(21) Appl. No.: 19/381,178

(22) Filed: Nov. 6, 2025

(30) Foreign Application Priority Data
Nov. 18, 2024 (DE) 10 2024 211 026.4

(51) Int. Cl. G01C 21/00; B60W 60/00

(52) U.S. Cl. CPC G01C 21/3844; B60W 60/001; B60W 2556/25; B60W 2556/40

(57) ABSTRACT

A method for creating a map. In the method, first, sensor data from a predetermined number of passes through a portion of a space are read in. Next, features in the sensor data are identified, wherein the features are identified separated onto multiple spatial regions of the portion of the space. The features are also assigned to a sensor position. Then, accuracy values for the features are ascertained, and each spatial region is assigned an accuracy value. Lastly, the map including the features related to sensor positions and the accuracy values of the spatial regions is generated.

### CROSS REFERENCE

The present application claims the benefit under 35 U.S.C. § 119 of Germany Patent Application No. DE 10 2024 211 026.4 filed on Nov. 18, 2024, which is expressly incorporated herein by reference in its entirety.

### FIELD

The present invention relates to a method for creating a map and a computing unit for carrying out the method. The present invention also relates to a control method and a control device for a vehicle.

### BACKGROUND INFORMATION

The related art describes certain methods for creating maps, in which geodata are acquired from land vehicles passing through the area to be mapped. These can be vehicles that comprise sophisticated sensor equipment (survey mapping, mobile mapping) and drive through the area systematically, or fleets of series-produced vehicles that comprise standard sensor equipment and cover the area by driving through it en masse (crowd mapping). Because of the limited perception horizon of the vehicles, this type of map creation can be prone to errors. Critically important here is the spatial referencing of the vehicle. If the location (position and orientation) of the vehicle is determined incorrectly, this error directly affects the accuracy of the map features.

### SUMMARY

An object of the present invention is to provide an improved method for creating a map and a computing unit for carrying out the method. Another object of the present invention is to provide a control method and a control device for a vehicle. These objects may be achieved by certain features of the present invention. Advantageous further developments of the present invention are disclosed herein.

According to a first aspect, the present invention relates to a method for creating a map. According to an example embodiment of the present invention, the method comprises the steps discussed in the following.

First, sensor data from a predetermined number of passes through a portion of a space are read in. The sensor data may have been recorded using identical sensors or also using different sensors, and in particular include image data from cameras, LiDAR data and radar data. The sensor data can also be georeferenced with GPS data or other satellite navigation data and/or inertial navigation data. The portion of space can include the area to be mapped or a subarea of the area to be mapped.

Next, features in the sensor data are identified, wherein the features are identified separated onto multiple spatial regions of the portion of the space. The portion of space is therefore divided into multiple spatial regions or is already divided into several spatial regions. The features can be identified by means of object detection, for example, and, among other things, can include road markings, traffic signs, trees and buildings on the side of a road.

The features are also assigned to a sensor position. The sensor position can be determined using GPS data, for instance, or other satellite navigation data and/or inertial navigation data; for example based on the georeferencing of the sensor data already described above.

Then, accuracy values for the features are ascertained, and each spatial region is assigned an accuracy value. It is therefore in particular the case that not every feature is assigned an accuracy value. Rather, an accuracy value for all of the features is ascertained across all of the features within a spatial region. The accuracy value can, for instance, indicate how reliable the features in the spatial region are, and this can be taken into account when the map is being used.

Lastly, the map consisting of features related to sensor positions and the accuracy values of the spatial regions is generated.

Specifying the accuracy values makes it possible to provide the reliability of the map for different spatial regions. The accuracy values can thus be used to adjust control commands for a vehicle derived from the map, for instance.

In one example embodiment of the method of the present invention, the accuracy value for each spatial region is evaluated based on a predetermined criterion. Only the spatial regions for which the accuracy value satisfies the predetermined criterion are used to generate the map. This makes it possible to achieve improved map creation.

In one example embodiment of the method of the present invention, the map for the spatial regions for which the accuracy value satisfies the predetermined criterion is output directly. In spatial regions for which the accuracy value does not satisfy the predetermined criterion, the map is submitted to manual review. This can be done automatically, for example, so that the map can be further processed directly and automatically in the spatial regions for which the accuracy value satisfies the predetermined criterion.

In one example embodiment of the method of the present invention, the map is output to a vehicle.

In one example embodiment of the method of the present invention, ascertaining the accuracy values for the features includes considering a statistical distribution of a deviation in the sensor data from different passes. This makes it easy to ascertain the accuracy.

In one example embodiment of the method of the present invention, the accuracy values for the features are ascertained such that deviations in the sensor data from different passes are characterized in terms of a deviation magnitude and a predetermined number of passes with the respective largest deviations are not taken into account when creating the map. This enables particularly simple implementation of the consideration of the accuracy.

In one example embodiment of the method of the present invention, further sensor data from further passes through the portion of the space are read in chronologically after generating the map, and the further method steps of the method are repeated taking into account the further sensor data.

According to a second aspect, the present invention relates to a computing unit comprising an input interface and a processor configured to carry out one of the described methods. The sensor data can be provided via the input interface. The computing unit optionally includes an output interface for outputting the map to a vehicle.

According to a third aspect, the present invention relates to a control method for a vehicle in which a map generated using one of the described methods of the present invention for generating a map is read in and then at least one driving function of the vehicle is controlled based on the map. Controlling the driving function can in particular include a steering movement, influencing acceleration and/or braking.

In one example embodiment of the control method of the present invention, controlling the driving function includes taking into account the accuracy values for the features.

According to a fourth aspect, the present invention relates to a control device for a vehicle that is configured carry out the control method.

Embodiment examples of the present invention are discussed with reference to the figures.

### BRIEF DESCRIPTION OF THE DRAWINGS

FIG. 1 shows a flow chart of a method for creating a map, according to an example embodiment of the present invention.

FIG. 2 shows an illustration relating to the determination of an accuracy value, according to an example embodiment of the present invention.

FIG. 3 shows another illustration relating to the determination of an accuracy value, according to an example embodiment of the present invention.

FIG. 4 shows a computing unit and vehicles, according to an example embodiment of the present invention.

FIG. 5 shows a flow chart of a control method according to an example embodiment of the present invention.

### DETAILED DESCRIPTION OF EXAMPLE EMBODIMENTS

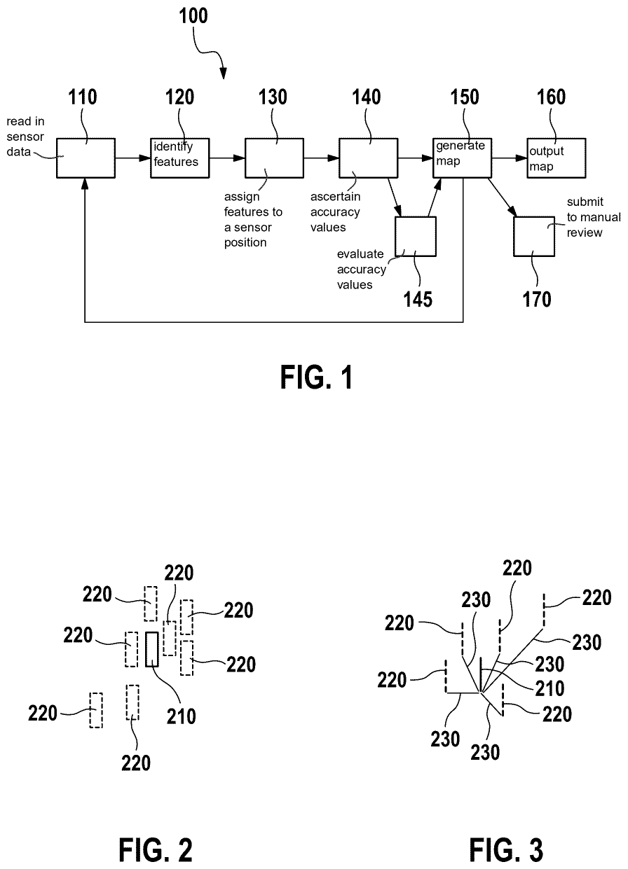

FIG. 1 shows a flow chart 100 of a method for creating a map. In a read-in step 110, sensor data from a predetermined number of passes through a portion of a space are read in. The sensor data may have been recorded using identical sensors or also using different sensors, and in particular include image data from cameras, LiDAR data and radar data. The sensor data can also be georeferenced with GPS data or other satellite navigation data and/or inertial navigation data. The portion of space can include the area to be mapped or a subarea of the area to be mapped.

In an identification step 120, features in the sensor data are then identified, wherein the features are identified separated onto multiple spatial regions of the portion of the space. The portion of space is therefore divided into multiple spatial regions or is already divided into several spatial regions. The features can be identified by means of object detection, for example, and, among other things, can include road markings, traffic signs, trees and buildings on the side of a road.

In an assignment step 130, the features are then assigned to a sensor position. The sensor position can be determined using GPS data, for instance, or other satellite navigation data and/or inertial navigation data; for example based on the georeferencing of the sensor data already described above.

In an ascertainment step 140, accuracy values for the features are then ascertained, and each spatial region is assigned an accuracy value. It is therefore in particular the case that not every feature is assigned an accuracy value. Rather, an accuracy value for all of the features is ascertained across all of the features within a spatial region. The accuracy value can, for instance, indicate how reliable the features in the spatial region are, and this can be taken into account when the map is being used.

In a generation step 150, the map consisting of features related to sensor positions and the accuracy values of the spatial regions is then generated.

Specifying the accuracy values makes it possible to provide the reliability of the map for different spatial regions. The accuracy values can thus be used to adjust control commands for a vehicle derived from the map, for instance.

The following describes embodiment examples of the method for creating a map that relate to individual mentioned steps of the method or introduce further steps into the method.

In one embodiment example of the method, the accuracy value for each spatial region is evaluated using a predetermined criterion in an evaluation step 145 which is carried out between the ascertainment step 140 and the generation step 150. Only the spatial regions for which the accuracy value satisfies the predetermined criterion are used to generate the map in the generation step 150. This makes it possible to achieve improved map creation.

In one embodiment example of the method, the map for the spatial regions for which the accuracy value satisfies the predetermined criterion is output directly in an output step 160. In spatial regions for which the accuracy value does not satisfy the predetermined criterion, the map is submitted to manual review in a submission step 170. This can be done automatically, for example, so that the map can be further processed directly and automatically in the spatial regions for which the accuracy value satisfies the predetermined criterion.

In one embodiment example of the method, the map is output to a vehicle in the output step 160.

In one embodiment example of the method, further sensor data from further passes through the portion of the space are read in chronologically after generating the map, and the further method steps of the method are repeated taking into account the further sensor data. After the generation step 150, it is thus in particular possible to repeat the read-in step 110, the identification step 120, the assignment step 130, the ascertainment step 140, and the output step 150 and, if necessary, also include the optional steps 145, 160, 170.

In one embodiment example of the method, ascertaining the accuracy values for the features in the ascertainment step 140 includes considering a statistical distribution of a deviation in the sensor data from different passes. This makes it easy to ascertain the accuracy. An example of this is shown in FIG. 2. Different passes can show a real object 210 as having different positions as the measured object 220. An average position of the measured objects 220 can be used as the position of the real object 210, for instance. A deviation distribution of the measured objects 220 from the real object 210 can be ascertained as well; for example in the form of a standard deviation or a variance. These values then provide a numerical value for the accuracy of the determination of the position of the real object 210. In the evaluation step 145, this numerical value can be used to select the objects included in the map; for example only objects the variance or standard deviation of which is below a predetermined value.

In one embodiment example of the method, the accuracy values for the features are ascertained in the ascertainment step 140 such that deviations in the sensor data from different passes are characterized in terms of a deviation magnitude and a predetermined number of passes with the respective largest deviations are not taken into account when creating the map in the creation step 150. This enables particularly simple implementation of the consideration of the accuracy. An example of this is shown in FIG. 3. Different passes can show a real object 210 as having different positions as the measured object 220. An average position of the measured objects 220 can be used as the position of the real object 210, for instance. The figure also shows deviation vectors 230 that quantify a deviation of the measured object 220 from the real object 210. It can in particular be provided that a predetermined number of measured objects 220 or a predetermined proportion of the measured objects 220 with deviation vectors 230 that are the largest in terms of magnitude are not used when creating the map in the creation step 150, and that this selection is made in the evaluation step 145.

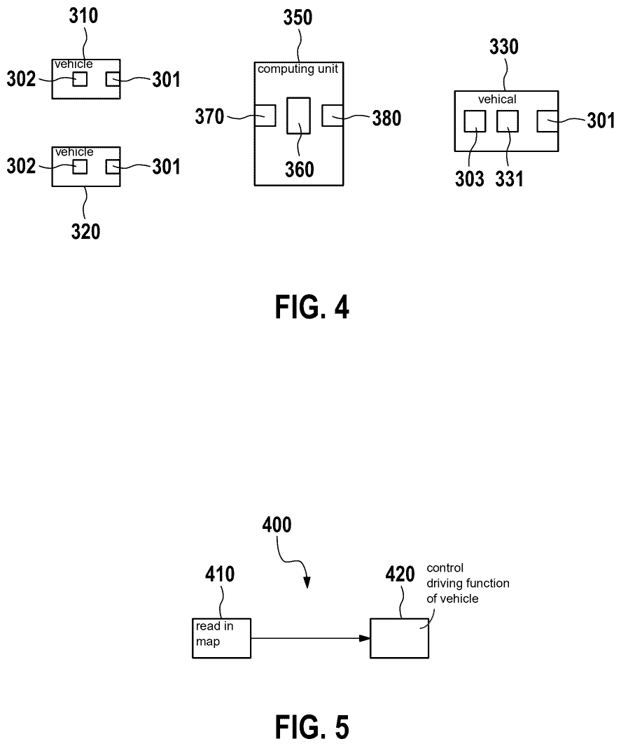

FIG. 4 shows three vehicles 310, 320, 330 and a computing unit 350. A first vehicle 310 and a second vehicle 320 each comprise a sensor 301 and an output interface 302, wherein sensor data from the sensors 301 can be output to the computing unit 350 via the output interface 302. The computing unit 350 comprises an input interface 370 via which the sensor data from the sensors 301 can be received. The computing unit 350 also comprises a processor 360. The computing unit is configured to carry out the method discussed in connection with FIG. 1 to 3. The computing unit 350 optionally includes an output interface 380 for outputting the map to a third vehicle 330. The third vehicle 330 also comprises a control device 331. It can also be provided that the map is also output to the first vehicle 310 and/or the second vehicle 320 via the output interface 380.

FIG. 5 shows a flow chart 400 of a control method for a vehicle; for example the third vehicle 330. In a read-in step 410, a map generated using the method for generating a map discussed in connection with FIG. 1 to 3 is read in. In a control step 420, a driving function of the vehicle is then controlled based on the map. Controlling the driving function can in particular include a steering movement, influencing acceleration and/or braking.

In one embodiment example of the control method, controlling the driving function includes taking into account the accuracy values for the features.

The control device 331 of the third vehicle 330 shown in FIG. 4 can be configured to carry out the control method of FIG. 5.

Although the present invention has been described in detail with reference to the preferred embodiment examples, the present invention is not limited to the disclosed examples and other variations can be derived from them by those skilled in the art without departing from the scope of the present invention.

What is claimed is:

1. A method for creating a map, comprising the following steps:
reading in sensor data from a predetermined number of passes through a portion of a space;
identifying features in the sensor data, wherein the features are identified separated onto multiple spatial regions of the portion of the space;
assigning the features to a sensor position;
ascertaining accuracy values for the features, wherein each of the spatial regions is assigned an accuracy value;
generating the map including those of the features related to sensor positions and the accuracy values of the spatial regions.

2. The method according to claim 1, wherein the accuracy value for each of the spatial regions is evaluated based on a predetermined criterion, and only those of the spatial regions for which the accuracy value satisfies the predetermined criterion are used to generate the map.

3. The method according to claim 2, wherein the map for those of the spatial regions for which the accuracy value satisfies the predetermined criterion is output directly, and, in those of the spatial regions for which the accuracy value does not satisfy the predetermined criterion, the map is submitted to manual review.

4. The method according to claim 1, wherein the map is output to a vehicle.

5. The method according to claim 1, wherein the ascertaining of the accuracy values for the features includes considering a statistical distribution of a deviation in the sensor data from different passes.

6. The method according to claim 1, wherein the ascertaining of the accuracy values for the features is carried out such that deviations in the sensor data from different passes are characterized in terms of a deviation magnitude and a predetermined number of passes with the respective largest deviations are not taken into account when creating the map.

7. The method according to claim 1, wherein further sensor data from further passes through the portion of the space are read in chronologically after generating the map, and certain steps of the method are repeated taking into account the further sensor data.

8. A computing unit, comprising:
an input interface; and
a processor;
wherein the computing unit is configured to carry out a method for creating a map, the method including the following steps:
reading in sensor data from a predetermined number of passes through a portion of a space,
identifying features in the sensor data, wherein the features are identified separated onto multiple spatial regions of the portion of the space,
assigning the features to a sensor position,
ascertaining accuracy values for the features, wherein each of the spatial regions is assigned an accuracy value,
generating the map including those of the features related to sensor positions and the accuracy values of the spatial regions.

9. A control method for a vehicle, comprising the following steps:
reading in a map generated using a method for creating a map, the method for creating the map including:
reading in sensor data from a predetermined number of passes through a portion of a space,
identifying features in the sensor data, wherein the features are identified separated onto multiple spatial regions of the portion of the space,
assigning the features to a sensor position,
ascertaining accuracy values for the features, wherein each of the spatial regions is assigned an accuracy value, and
generating the map including those of the features related to sensor positions and the accuracy values of the spatial regions; and
controlling at least one driving function of the vehicle using the map.

10. A control device for a vehicle, the control device configured to carry out a control method for the vehicle, the method comprising following steps:
reading in a map generated using a method for creating a map, the method for creating the map including:
reading in sensor data from a predetermined number of passes through a portion of a space,
identifying features in the sensor data, wherein the features are identified separated onto multiple spatial regions of the portion of the space,
assigning the features to a sensor position,
ascertaining accuracy values for the features, wherein each of the spatial regions is assigned an accuracy value, and
generating the map including those of the features related to sensor positions and the accuracy values of the spatial regions; and
controlling at least one driving function of the vehicle using the map.
